(19) United States
(12) Patent Application Publication
(10) Pub. No.: US 2019/0062137 A1
(43) Pub. Date: Feb. 28, 2019

(54) AUTOMATED FILLING SYSTEMS AND METHODS

(71) Applicant: Intel IP Corporation, Santa Clara, CA (US)

(72) Inventors: Roman Schick, Krailling (DE); Fengqian Gao, Santa Clara, CA (US); Wenlong Yang, Shanghai (CN); Daniel Pohl, Puchheim (DE)

(73) Assignee: Intel IP Corporation, Santa Clara, CA (US)

(21) Appl. No.: 15/684,764

(22) Filed: Aug. 23, 2017

(51) Int. Cl. B67D 1/00; B67D 1/08; B67D 1/12; G06T 17/10; G06T 7/62

(52) U.S. Cl. CPC B67D 1/0034; B67D 1/0888; B67D 1/1247; G06T 2207/10021; G06T 7/62; G06T 2207/10048; G06T 2207/10004; G06T 17/10

(57) ABSTRACT

The present disclosure is directed to systems and methods for automated generation of a three-dimensional model of a container prior to dispensing material into the container. Using the three-dimensional model of the container, the systems and methods determine an available internal volume of the container and a fill volume of the container that takes into consideration one or more material parameters, such as material temperature. Using the determined fill volume, the systems and methods dispense one or more materials into the container to the determined fill volume. Where a plurality of materials are dispensed, the systems and methods may use a recipe to determine appropriate volumes of each of a plurality of materials to dispense to the container to provide the determined fill volume. Such systems and methods beneficially account for objects present in the container prior to dispensing materials into the container.

### TECHNICAL FIELD

The present disclosure relates to depth sensing, automated filling systems.

### BACKGROUND

Automated filling machines find widespread use in many diverse applications. From liquid filling operations, such as soft drink and coffee machines to solid filling operations, such as packaging goods for shipment, each filling operation shares one requirement—do not overfill or underfill the container in question. Filling operations often encounter different size and shape containers. However, most automated filling systems are unable to handle more than a few standard sizes. For example, a beverage dispensing system may offer SMALL, MEDIUM, and LARGE options that correspond to cups supplied by the beverage distributor, but bear no correspondence to the thermos or insulated cup brought from home. Similarly, a packaging system may be configured to fill standard size containers to a defined level with packing material, however non-standard size containers and containers having differently sized objects or different numbers of objects may result in overfill or underfilling of the container.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 depicts an illustrative automated filling system that includes data acquisition system, dimensioning circuitry, available volume circuitry, fill volume circuitry, and dispensing circuitry communicably coupled to a material dispenser, in accordance with at least one embodiment described herein;

FIG. 2 is an input/output (I/O) diagram depicting illustrative dimensioning circuitry, in accordance with at least one embodiment described herein;

FIG. 3 is an input/output (I/O) diagram depicting illustrative available volume circuitry, in accordance with at least one embodiment described herein;

FIG. 4 is an input/output (I/O) diagram depicting illustrative fill volume circuitry, in accordance with at least one embodiment described herein;

FIG. 5 is an input/output (I/O) diagram depicting illustrative dispensing circuitry, in accordance with at least one embodiment described herein;

FIG. 6A is a schematic diagram of a system that includes an illustrative data acquisition system that uses a plurality of image acquisition devices to capture a stereoscopic image of the container from which three-dimensional model data may be extracted, in accordance with at least one embodiment described herein;

FIG. 6B is a schematic diagram of a system that includes an illustrative data acquisition system that uses a structured light illuminator and one or more image acquisition devices from which three-dimensional model data may be extracted, in accordance with at least one embodiment described herein;

FIG. 7 depicts a system that includes an illustrative structured light data acquisition system capable of including one or more objects disposed in the container in the three-dimensional model data provided to the dimensioning circuitry, in accordance with at least one embodiment described herein;

FIG. 8 depicts a system that includes an illustrative structured light data acquisition system capable of detecting a level in a container, in accordance with at least one embodiment described herein;

FIG. 9 is a block diagram of an illustrative processor based device that includes an automated filling system such as depicted in FIGS. 1 through 8, in accordance with at least one embodiment described herein; and

FIG. 10 is a high-level logic flow diagram of an illustrative method of generating a three-dimensional model of a container and automatically dispensing material into the container to determined fill volume determined based, at least in part, on the three-dimensional model, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The systems and methods disclosed herein provide automated filling of both standard and non-standard sized containers with a material that may include solids or liquids. The systems and methods contained herein beneficially and advantageously determine an appropriate fill volume for a container based on a three-dimensional model of the container and taking into consideration the presence of objects, such as ice cubes, already in the container. Using such a volumetric approach, the systems and methods described herein beneficially and advantageously permit the automated filling based on a recipe or ratios between two or more materials added to the container. For example, a coffee drink may include espresso and steamed milk at a defined ratio. By determining the fill volume, the systems and methods contained herein permit the precise dispensing of the correct amount of espresso and the precise dispensing of the correct amount of steamed milk into a container such as a coffee cup. Previously, in response to an underfill, one could add more espresso or more steamed milk, however the added liquid would throw off the desired ratio of ingredients (and adversely impact the taste and/or quality of the beverage). The ability to provide any volume of a blended material therefore represents a significant improvement over prior automated filling solutions.

The automated filling systems and methods described herein generate a three-dimensional model of the container using one or more modeling techniques prior to dispensing any material into the container. In some embodiments, the automated filling systems and methods described herein make use of a stereoscopic camera array to construct a three-dimensional model of the container that includes any objects that may be present in the container to determine an appropriate fill volume for the container. In some embodiments, the automated filling systems and methods described herein make use of a structured light illuminator and image acquisition device to construct a three-dimensional model of the container that includes any objects that may be present in the container to determine an appropriate fill volume for the container. In such embodiments, the structured light illuminator may include a visible light illuminator (i.e., a structured light illuminator having an electromagnetic output with wavelengths between 390 nanometers and 700 nanometers). In such embodiments, the structured light illuminator may include an infrared illuminator (i.e., a structured light illuminator having an electromagnetic output with wavelengths greater than 700 nanometers). In embodiments, the automated filling systems and methods described herein beneficially determine the fill volume prior to dispensing material into the container and do not rely upon measuring the level of material as material is dispensed into the container. Thus, the systems and methods described herein are advantageously resistant to interference caused by steam, splashing, dust, and/or debris created while dispensing the material into the container.

An automated dispensing system is provided. The system may include: a data acquisition system to obtain a three-dimensional model of a container; dimensioning circuitry to determine at least one physical dimension of the container using the three-dimensional model of the container; available internal volume circuitry to determine an available internal volume of the container based, at least in part on the at least one detected physical dimension of the container; fill volume circuitry to determine a fill volume to provide a defined fill level within the container based on the determined available internal volume of the container; and dispensing circuitry to dispense the fill volume of at least one material into the container.

An automated dispensing method is provided. The method may include: generating a three-dimensional model of a container using a data acquisition system; determining, by dimensioning circuitry, at least one physical dimension of the container using the generated three-dimensional model; determining, by available internal volume circuitry, an available internal volume of the container using the at least one determined physical dimension of the container; determining, by fill volume circuitry, a fill volume to provide a defined fill level within the container based on the available internal volume of the container; and dispensing, by dispensing circuitry, the fill volume of at least one material into the container.

A non-transitory machine-readable storage medium is provided. The machine-readable storage medium may contain instructions that, when executed, cause controller circuitry to: cause a data acquisition system to generate a three-dimensional model of a container; cause dimensioning circuitry to determine a at least one internal physical dimension of the container based, at least in part, on the three-dimensional model of the container; cause available internal volume circuitry to determine an available internal volume of the container using the at least one internal physical dimension of the container; cause fill volume circuitry to determine a fill volume to provide a defined fill level within the container based on the available internal volume in the container; and

cause dispensing circuitry to dispense the fill volume of at least one material into the container.

An automated dispensing system is provided. The system may include: a means for generating a three-dimensional model of a container; a means for determining at least one physical dimension of the container using the generated three-dimensional model; a means for determining an available internal volume of the container using the at least one determined physical dimension of the container; a means for determining a fill volume to provide a defined fill level within the container based on the available internal volume of the container; and a means for dispensing the fill volume of at least one material into the container.

As used herein the terms “top,” “bottom,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, the term “logically associated” when used in reference to a number of objects, systems, or elements, is intended to convey the existence of a relationship between the objects, systems, or elements such that access to one object, system, or element exposes the remaining objects, systems, or elements having a “logical association” with or to the accessed object, system, or element. An example “logical association” exists between relational databases where access to an element in a first database may provide information and/or data from one or more elements in a number of additional databases, each having an identified relationship to the accessed element. In another example, if “A” is logically associated with “B,” accessing “A” will expose or otherwise draw information and/or data from “B,” and vice-versa.

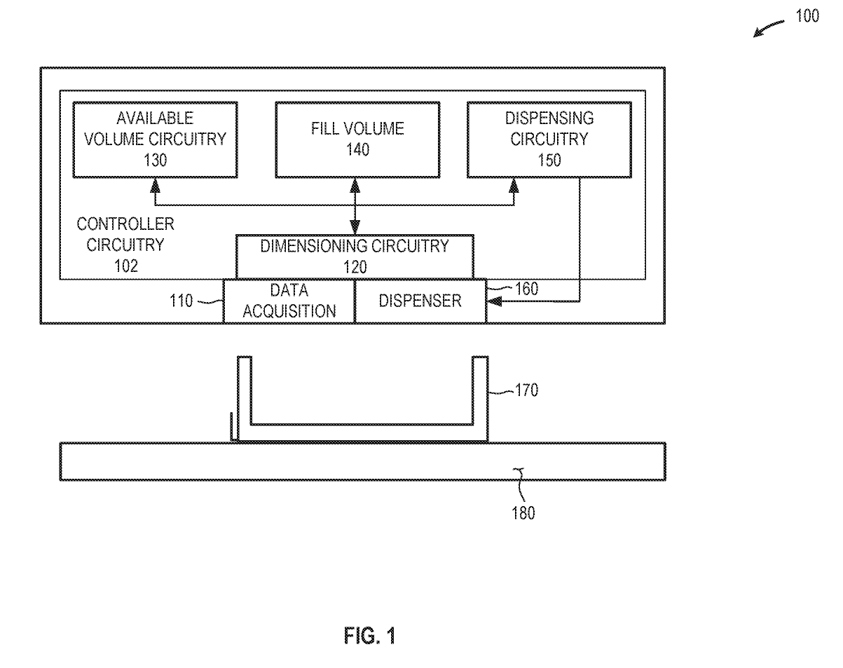

FIG. 1 depicts an illustrative automated filling system 100 that includes data acquisition system 110, dimensioning circuitry 120, available volume circuitry 130, fill volume circuitry 140, and dispensing circuitry 150 communicably coupled to a material dispenser 160, in accordance with at least one embodiment described herein. The automated filling system 100 may be used to fill a container 170 that may remain static beneath the automated filling system 100 or may be moved beneath the automated filling system 100 via a conveyance 180, such as an automated filling line or conveyor belt.

In operation, the data acquisition system 110 obtains a three-dimensional scan of the container 170 placed or positioned beneath the automated filling system 100. The data acquisition system 110 communicates at least some of the three-dimensional scan information to the dimensioning circuitry 120. The dimensioning circuitry 120 determines one or more physical dimensions of the container 170 using the three-dimensional scan information received from the data acquisition system 110. The dimensioning circuitry 120 communicates at least some of the one or more physical dimensions to the available volume circuitry 130.

The available volume circuitry 130 determines the available internal volume of the container 170. The available volume circuitry 130 communicates data representative of the available internal volume of the container 170 to the fill volume circuitry 140. The fill volume circuitry 140 determines an appropriate material fill volume for the container 170 based at least on the determined available internal volume provided by the available volume circuitry 130. In embodiments, the fill volume circuitry 140 may use other information, data, or factors in determining the fill volume of material to add to the container 170. For example, the fill volume circuitry 140 may fill the available internal volume of a container 170 such as a cup to a 90% level for a cold drink (e.g., a drink having a temperature of less than 80° F.) and to an 80% level for a hot drink (e.g., a drink having a temperature above 80° F.).

The fill volume circuitry 140 communicates data representative of the fill volume to the dispensing circuitry 150. The dispensing circuitry 150 communicably couples to the material dispenser 160 and causes the material dispenser 160 to charge the fill volume of material into the container 170. Since different solid and liquid materials may be dispensed by weight or other measurable parameters, the dispensing circuitry 150 may convert the determined fill volume provided by the fill volume circuitry 140 to one or more other measurable parameters. For example, the dispensing circuitry 150 may use a bulk density to convert the determined fill volume into a fill weight. In some embodiments, the dispensing circuitry 150 may charge a plurality of materials into the container 170 using a recipe or similar defined material allocation or proportions. In such embodiments, the sum of the respective volumes of each of the plurality of materials charged to the container 170 may total the determined fill volume. For example, the dispensing circuitry 150 may dispense ice totaling 20% of the determined fill volume into a container 170 and may dispense a soft drink totaling 80% of the determined fill volume into the container 170.

In embodiments, the dimensioning circuitry 120, the available volume circuitry 130, the fill volume circuitry 140, and/or the dispensing circuitry 150 may be distributed, disposed, incorporated into, or form at least a portion of controller circuitry 102. In embodiments, the controller circuitry 102 may include any number and/or combination of electronic components, semiconductor devices, logic elements, or combinations thereof. In embodiments, the controller circuitry 102 may include one or more systems or devices capable of executing machine-readable instruction sets and/or machine-readable logic. The controller circuitry 102 may include one or more: single- or multi-core processors; single- or multi-core microprocessors, controllers, microcontrollers, systems-on-a-chip (SoCs), application specific integrated circuits (ASICs), programmable gate arrays, digital signal processors (DSPs), reduced instruction set computers (RISCs), hard-wired circuits, or combinations thereof. In embodiments, the controller circuitry 102 may execute one or more machine-readable instruction sets to provide the functionality and/or capabilities of the dimensioning circuitry 120, the available volume circuitry 130, the fill volume circuitry 140, and/or the dispensing circuitry 150.

The data acquisition system 110 may include any number and/or combination of systems and/or devices capable of providing data representative of a three-dimensional model of a physical object, such as container 170. The data acquisition system 110 may use a non-contact active three-dimensional scanning technique or a non-contact passive three-dimensional scanning technique to develop the three-dimensional model of the container 170. Beneficially, the three-dimensional model of the container 170 is generated prior to dispensing material into the container, thereby minimizing or even preventing detrimental interference with the three-dimensional model generation based on vapors, stem, dust, or similar aerosols emitted from the container 170 during filling. Existing systems that employ continuous level detection to fill a container are particularly susceptible to such interference from vapors, stem, dust, or similar aerosols emitted from the container 170 during filling. In some implementations, the data acquisition system 110 may be fixed with respect to the physical object. In other implementations, the data acquisition system 110 may be moveable with respect to the physical object. For example, the data acquisition system 110 may partially or completely pivot about the extent of the physical object to generate a three-dimensional representation or model of the physical object.

Example active three-dimensional scanning techniques include, but are not limited to, time-of-flight laser scanning, triangulation-based laser scanning, conoscopic laser scanning, structured light scanning, and modulated light scanning. The RealSense® R200 infrared, structured light, three-dimensional scanning system as manufactured by Intel®, Inc. (SANTA CLARA, Calif.) provides an illustrative example of an active, non-contact, three-dimensional data acquisition system 110.

Example passive three-dimensional scanning techniques include, but are not limited to: stereoscopic scanning using a plurality of image acquisition devices, and photometric scanning using a single image acquisition device under a variety of lighting conditions and/or angles. The RealSense® R100 stereoscopic, three-dimensional scanning system as manufactured by Intel®, Inc. (SANTA CLARA, Calif.) provides an illustrative example of a passive, non-contact, three-dimensional data acquisition system 110.

Irrespective of the technology employed in creating the three-dimensional model of the container 170, the data acquisition system 110 communicates at least a portion of the three-dimensional model data to the dimensioning circuitry 120. The dimensioning circuitry 120 determines at least one physical dimension associated with the internal volume of the container 170. For example, where the container 170 is a hollow, right, cylindrical vessel, the dimensioning circuitry 120 may extract an internal diameter and an internal height of the container 170 from the three-dimensional model data provided by the data acquisition system 110. In another example, where the container 170 is a hollow, conical frustum, the dimensioning circuitry 120 may extract a bottom internal diameter, a top internal diameter, and an internal height of the container 170 from the three-dimensional model data provided by the data acquisition system 110. One may readily appreciate a greater number of physical dimensions may be needed to determine the volume of a complex-shaped container, such as a container 170 shaped like a bear, football helmet, etc. The dimensioning circuitry 120 communicates the at least one physical dimension to the available volume circuitry 130.

The available volume circuitry 130 may include any number and/or combination of systems and/or devices capable of determining all or a portion of the internal volume of the container 170. The available volume circuitry 130 determines the available internal volume of the container 170 using the at least one physical dimension provided by the dimensioning circuitry 120. In some implementations, the available volume circuitry 130 may directly calculate the available internal volume of the container 170. For example, where the container 170 is a right cylindrical vessel, the available volume circuitry 130 may directly determine the available internal volume of the container using the formula:

V=πR²h (1)
Where: V=container volume
   R=internal radius
   h=internal height

In another example, where the container 170 is a conical frustum, the available volume circuitry 130 may directly determine the available internal volume of the container using the formula:

V=⅓πh(R₁²+R₂²+R₁R₂) (2)
Where: V=container volume
   R₁=internal radius at bottom of frustum
   R₂=internal radius at top of frustum
   h=internal height

In embodiments, the available volume circuitry 130 may determine the available internal volume of the container 170 using one or more numerical integration techniques, particularly when the container is an odd, irregular, or non-standard shape. Such numerical integration techniques may take the form of a summation of a plurality of horizontal or vertical “slices” or “segments” of the interior space where the volume occupied by each of the slices or segments is determinable to within a defined limit or within a defined permissible error.

In embodiments, the available volume circuitry 130 may determine the available internal volume of the container 170 is the full, determined, internal volume of the container 170 (i.e., 100% of the available internal volume). In other embodiments, the available volume circuitry 130 may determine the available internal volume of the container 170 is a percentage of the determined, internal volume of the container 170 (e.g., anything less than 100% of the available internal volume). For example, if a solid material such as packing peanuts are being dispensed into a box with upturned box flaps, the calculate available internal volume will include the volume formed by the upturned box flaps. In such an embodiment, the actual available internal volume may only be 60% to 70% of the calculated available internal volume. The available volume circuitry 130 communicates data representative of the available internal volume of the container to the fill volume circuitry 140.

The fill volume circuitry 140 receives the data representative of the available internal volume of the container from the available volume circuitry 130. The fill volume circuitry 140 may include any number and/or combination of electronic components, semiconductor devices, and/or logic elements capable of receiving the data representative of the available internal volume of the container 170 and determining an appropriate fill volume for the container 170. The appropriate fill volume for the container 170 may be determined using a number of factors. For example, a completely full container 170 is difficult to move without spilling, so a default appropriate fill volume may be 90% to 95% of the available internal volume of the container 170. Splashing or spilling of cold materials is less hazardous than splashing or spilling of hot materials. Therefore, an appropriate fill volume for cold materials may be 85% to 95% of the available internal volume while hot materials may be 80% to 85% of the available internal volume to allow for movement of the material within the container while minimizing the likelihood that the material will spill from the container 170. In another example, if the material being dispensed foams or develops a “head” during dispensing (e.g. beer, soft drinks), the appropriate fill volume may be 80% to 85% of the available internal volume to allow for the foam or “head” that will form when the material is dispensed. The fill volume circuitry 140 communicates data representative of the fill volume to the dispensing circuitry 150.

The dispensing circuitry 150 receives the data representative of the fill volume from the fill volume circuitry 140. The dispensing circuitry 150 may include any number and/or combination of electronic components, semiconductor devices, and/or logic elements capable of receiving representative of the fill volume from the fill volume circuitry 140 and dispensing the fill volume of material to the container 170. In embodiments, the dispensing circuitry 150 may dispense a single material into the container 170. In other embodiments, the dispensing circuitry 150 may receive data representative of a recipe in which a plurality of materials is dispensed in defined volumes that total the fill volume. Such recipes may include recipes that dispense a plurality of liquid materials into the container 170. Such recipes may include recipes that dispense a plurality of solid materials into the container 170. Such recipes may include recipes that dispense a combination of at least one liquid material and at least one solid material into the container 170.

For example, a one liter container 170 may have an available internal volume of 900 cubic centimeters (cm³) for a cold liquid material, such as a soft drink. The dispensing circuitry 150 may receive a recipe for use with soft drinks that indicates a fill volume of 80% of the available internal volume (720 cm³) to account for the head that develops as the soft drink is dispensed into the container. The recipe received by the dispensing circuitry 150 may also indicate that a first, solid, material (i.e., ice) should be dispensed to 25% of the fill volume (180 cm³) and a second, liquid, material (i.e., the soft drink) should be dispensed to 75% of the fill volume (540 cm³). Using this recipe, after dispensing the soft drink and ice into the container 170, the top of the head on the dispensed soft drink should be at about 90% of the fill volume of the container 170.

In another embodiment, the dispensing circuitry 150 may dispense only a single material, but may apportion the dispensing into a plurality of equal or unequal volume portions to account for the propensity of the material to foam or develop a head. In such embodiments, the dispensing circuitry 150 may be programmed to delay for a variable, but defined, amount of time between successive dispensings of the material. For example, the dispensing circuitry may apportion a 600 cm³ dispensing of beer to a container 170 into three (3), equal, portions of 200 cm³ each with each portion separated from the subsequent portion by 20 seconds to permit the head formed during dispensing to recede prior to dispensing additional beer to the container 170.

The fill volume circuitry 140 provides the dispensing circuitry 150 with data representative of the fill volume for the container 170. In embodiments, certain materials may be more easily, accurately, and/or efficiently dispensed by weight rather than by volume. In such embodiments, the dispensing circuitry 150 may use one or more physical properties of the material to convert a volume of material to an equivalent weight of material. In other implementations, the dispensing circuitry 150 may determine a weight of one or more materials being dispensed into a container 170. Such may beneficially warn or even prevent an overload condition where the material meets the determined fill volume but exceeds a defined physical parameter, such as weight. For example, the dispensing circuitry 150 may warn if the weight of a container 170 exceeds a defined threshold, such as a weight threshold to qualify for First Class mail. The dispensing circuitry 150 may therefore control both the material selection (in implementations where multiple materials are being dispensed to the container 170) and the operation of the dispenser 160. The dispensing circuitry 150 is operably coupled to the dispenser 160 and controls the operation of the dispenser 160.

The dispenser 160 receives at least one signal from the dispensing circuitry 150. In embodiments, the dispenser 160 receives an ON/OFF signal from the dispensing circuitry 150 that switches the dispenser 160 from a STANDBY state to and ACTIVE state and vice-versa. In embodiments, the dispenser 160 may receive a dispensing speed or similar signal from the dispensing circuitry 150 that includes information and/or data to control the rate at which the dispenser 160 dispenses material to the container 170. In embodiments, the dispenser 160 may receive a material selection or similar signal from the dispensing circuitry 150 that includes information and/or data indicative to select a material that the dispenser 160 dispenses to the container 170.

The dispenser 160 may include any number and/or combination of systems and/or devices capable of dispensing one or more materials to the container 170 responsive to receipt of one or more signals received from the dispensing circuitry 150. The dispenser 170 may dispense one or more liquid materials, one or more solid materials, or any combination thereof to the container 170. The dispenser 170 may include one or more reservoirs in which the materials dispensed to the container 170 may be stored in bulk quantities, such as quantities greater than 5×, 10×, 20×, 50× or 100× the expected quantity dispensed to the container 170. The dispenser 160 may include conveyances that fluidly couple and/or physically link the reservoir to the discharge point at which the materials are dispensed to the container 170. In embodiments, the conveyances may be manually or automatically adjusted to provide different material feed rates to the container 170.

The automated filling system 100 generates a three-dimensional model, determines the available internal volume, and determines a fill volume that takes into consideration properties of the fill material, for each container 170 prior to filling. Such an arrangement provides multiple benefits. First, by generating a three-dimensional model of the container 170 prior to filling, virtually any container size, shape or configuration may be safely filled to a defined level, thereby offering considerable operational flexibility. Second, by determining a fill volume prior to dispensing material into the container 170, monitoring the level in the container 170 during filling is unnecessary.

The container 170 may have any size, shape, or configuration. The container 170 may be configured to retain liquids, solids, or combinations thereof. The container 170 may have a regular (e.g., cylindrical) or irregular (e.g., bear-shaped) shape or configuration. In embodiments, the container 170 may remain static beneath the data acquisition system 110 and the dispenser 160. In other embodiments, a conveyance 180 may move the container beneath either or both the data acquisition system 110 and the dispenser 160.

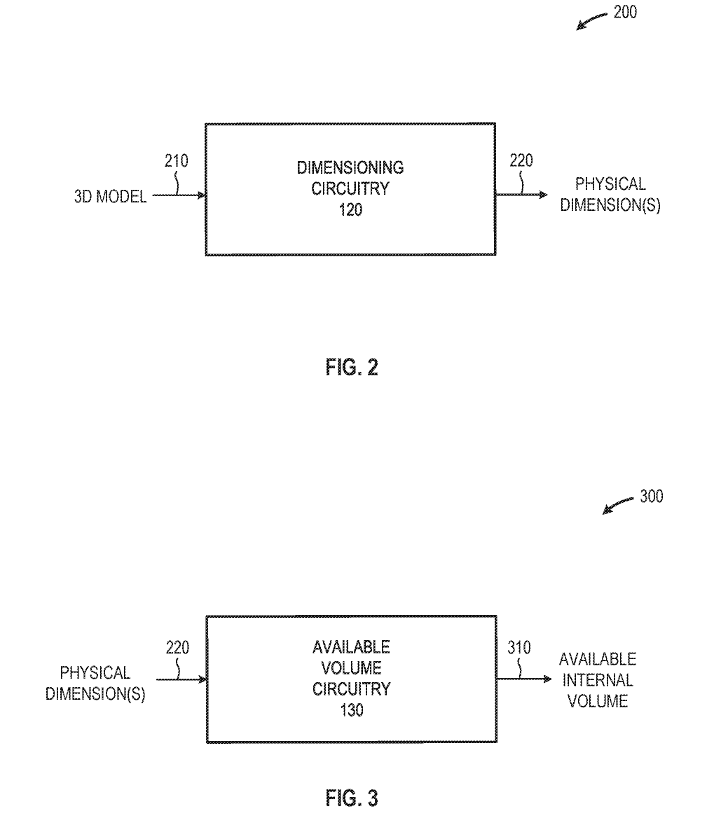

FIG. 2 is an input/output (I/O) diagram 200 depicting illustrative dimensioning circuitry 120, in accordance with at least one embodiment described herein. The dimensioning circuitry 120 receives one or more signals 210 from the data acquisition system 110. The one or more signals 210 include information and/or data representative of a three-dimensional model of the container 170. The signal 210 is communicated from the data acquisition system 110 to the dimensioning circuitry 120 prior to dispensing material to the container.

The dimensioning circuitry 120 may include any combination of fixed and/or configurable circuits, electrical components, semiconductor devices, and/or logic elements. The dimensioning circuitry 120 receives a signal 210 that includes three-dimensional model data representative of the container 170 and determines one or more physical dimensions of the container 170 using the three-dimensional model data. In embodiments, the dimensioning circuitry 120 determines one or more internal physical dimensions that define the void space existent in the container 170. The dimensioning circuitry 120 generates an output signal 220 that includes one or more physical dimensions associated with the container 170.

In some implementations, the dimensioning circuitry 120 may identify the physical shape of the container 170 where the form of the container represents a standard shape, such as cylindrical, conical frustum, spherical, conical, etc. The dimensioning circuitry 120 may include one or more data libraries, data stores, data structures, or databases that include data representative of such standard shapes and the dimensioning circuitry 120 may compare the received three-dimensional model data with such data structures to identify the shape of the container 170. In such embodiments, the output signal 220 generated by the dimensioning circuitry 120 may include information and/or data identifying the shape of the container 170.

In embodiments, the dimensioning circuitry 120 may determine physical dimensions based, at least in part, on the shape or configuration of the container 170. Thus, for a cylindrical container 170 having a constant internal diameter, the dimensioning circuitry 120 may determine only two internal physical dimensions—an internal diameter and an internal height. In contrast, for an irregularly shaped container 170, the dimensioning circuitry 120 may section or segment the internal space in the container 170 into a plurality of “slices,” each having one or more physical dimensions associated therewith. The volume of each individual slice may be summed (numerically integrated) to determine the available internal volume of the container 170. The number of such “slices” may vary based on the complexity of the internal space within the container 170. For example, the internal volume of the container 170 may be segmented into about 5 or more slices; about 10 or more slices; about 25 or more slices; about 50 or more slices; or about 100 or more slices.

In embodiments, the dimensioning circuitry 120 may provide such “slice” data regardless of the shape or configuration of the container 170. In such instances, the available volume circuitry 130 may perform a numerical integration to determine the available internal volume of the container 170.

FIG. 3 is an input/output (I/O) diagram 300 depicting illustrative available volume circuitry 130, in accordance with at least one embodiment described herein. The available volume circuitry 130 receives, as an input, the signal 220 containing information and/or data indicative of the internal physical dimensions of the container 170. The signal 220 is communicated from the dimensioning circuitry 120 to the available volume circuitry 130 prior to dispensing material to the container 170.

The available volume circuitry 130 may include any combination of fixed and/or configurable circuits, electrical components, semiconductor devices, and/or logic elements. The available volume circuitry 130 receives the signal 220 that includes data representative of the internal physical dimensions of the container 170 and determines the available internal volume of the container 170 using the received internal physical dimensions. The available volume circuitry 130 generates an output signal 310 that includes information and/or data representative of the available internal volume associated with the container 170.

In embodiments, the available volume circuitry 130 may use information and/or data received in signal 220 from the dimensioning circuitry 120 that identifies the container 170 as a standard shape. In such embodiments, the available volume circuitry 130 may use one or more stored mensuration formulae associated with the identified shape to determine the available internal volume of the container 170. In other embodiments, the available volume circuitry 130 may use information and/or data received in signal 220 from the dimensioning circuitry 120 that includes physical dimensions for each of a plurality of “slices” of the internal volume of container 170. In such embodiments, the available volume circuitry 130 may numerically integrate the slices to determine the available internal volume of the container 170. The available volume circuitry 130 generates an output signal 310 that includes information and/or data indicative of the available internal volume of container 170.

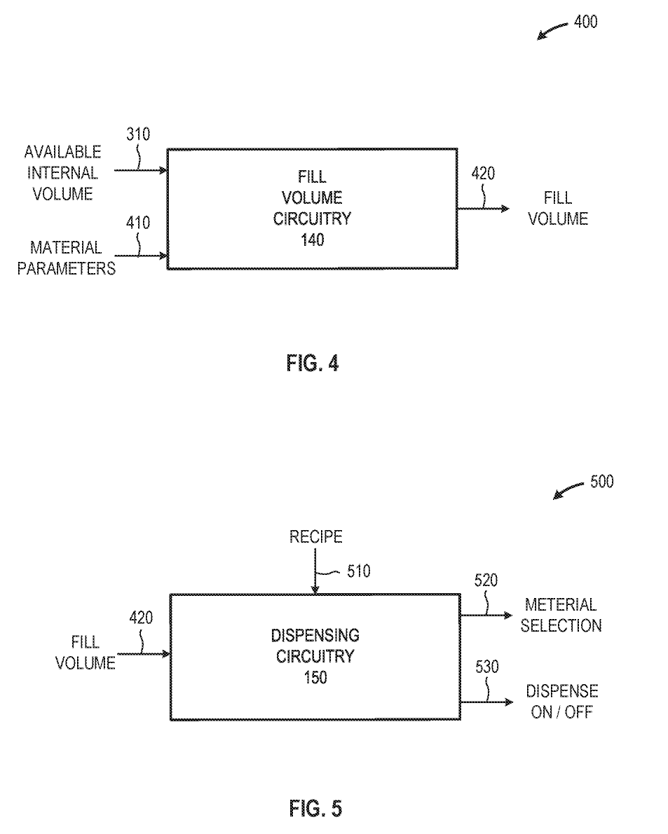

FIG. 4 is an input/output (I/O) diagram 400 depicting illustrative fill volume circuitry 140, in accordance with at least one embodiment described herein. The fill volume circuitry 140 receives, as inputs: the output signal 310 from the available volume circuitry 130 containing information and/or data indicative of the available internal volume of the container 170; and signal 410 that includes information and/or data regarding the material for dispensing into the container 170. The fill volume circuitry 140 generates an output signal 420 that includes information and/or data indicative of the fill volume in the container 170. The fill volume circuitry 140 communicates the output signal 420 to the dispensing circuitry 150. The signal 420 is communicated from the fill volume circuitry 130 to the dispensing circuitry 150 prior to dispensing material to the container 170.

The fill volume circuitry 140 may include any combination of fixed and/or configurable circuits, electrical components, semiconductor devices, and/or logic elements. Using the data representative of the available internal volume in container 170 and information representative of the material to dispense into the container 170, the fill volume circuitry determines an appropriate fill volume for the container 170. Material properties may impact the volume of material dispensed into the container 170. For example, the fill volume for materials at lower temperatures (i.e., “cold” materials, such as beer and soft drinks) may be greater (i.e., the liquid level in the container will be higher) than the fill volume for materials at elevated temperatures (i.e., “hot” materials, such as tea and coffee) to minimize the likelihood that the elevated temperature material will spill or slosh from the container 170. In another example, if the material being dispensed foams or develops a “head” during dispensing (e.g. beer, soft drinks) the fill volume may be reduced to account for the foam or “head” that will form when the material is dispensed to the container. The fill volume circuitry 140 generates an output signal 420 that includes information and/or data indicative of the determined fill volume in container 170.

The signal 410 includes information and/or data indicative of one or more properties of the material for dispensing into the container 170. Such material property information may include, but is not limited to: material temperature and the propensity for the material to foam on dispensing. In some implementations, the fill volume circuitry 140 may consider whether additional materials may or will be added to the container after the material is dispensed. For example, olives or similar garnishes may be added after a mixed drink is dispensed. In such implementations, the fill volume circuitry 140 may reduce the fill volume to account for the volume occupied by an object placed in the container 170 after filling. In another example, ice may be added to a cold drink after dispensing. In such implementations, the fill volume circuitry 140 may reduce the fill volume to account for the volume occupied by ice added to the container 170 after filling.

FIG. 5 is an input/output (I/O) diagram 500 depicting illustrative dispensing circuitry 150, in accordance with at least one embodiment described herein. The dispensing circuitry 150 receives, as inputs: the output signal 420 from the fill volume circuitry 140 containing information and/or data indicative of the fill volume of the container 170; and signal 510 that includes information and/or data regarding a recipe that includes type and quantity of each material for dispensing into the container 170. The dispensing circuitry 150 generates a first output signal 520 that includes information and/or data indicative of the selected material for dispensing and a second output signal 530 that toggles the dispenser 160 between an ON state and an OFF state.

The dispensing circuitry 150 may include any combination of fixed and/or configurable circuits, electrical components, semiconductor devices, and/or logic elements. Using the data representative of the fill volume in container 170 and recipe information representative of the type and proportion of one or more materials to dispense into the container 170, the dispensing circuitry 150 causes the dispenser 160 to dispense the appropriate material(s) in the container 170 in the correct quantities or proportions.

For example, a recipe for a soft drink dispensing may call for a solid material (i.e., ice) to 25% of the fill volume and a liquid material (i.e., the soft drink) to 75% of the fill volume. Upon receipt of this recipe and upon receipt of the fill volume information from the fill volume circuitry 140, the dispensing circuitry 150 causes the dispenser 160 to dispense the appropriate quantity of ice and the appropriate quantity of soft drink into the container 170. In another example, a recipe for a mixed drink may call for a 3 to 1 ratio of gin to vermouth and to allow sufficient volume for adding 2 olives to the container after dispensing the gin and vermouth. Upon receipt of this recipe and upon receipt of fill volume information (e.g., 90% full on a 10-ounce Martini glass container 170, or a fill volume equal to 9 ounces), the dispensing circuitry 150 determines a 1 ounce allowance for later addition of 2 olives yields 6 ounces of gin and 2 ounces of vermouth to provide a liquid volume of 8 ounces which maintains the 3:1 ratio of gin to vermouth while providing a 1 ounce allowance for the addition of olives to provide a fill volume of 9 ounces total (8 ounces liquid+1 ounce solid).

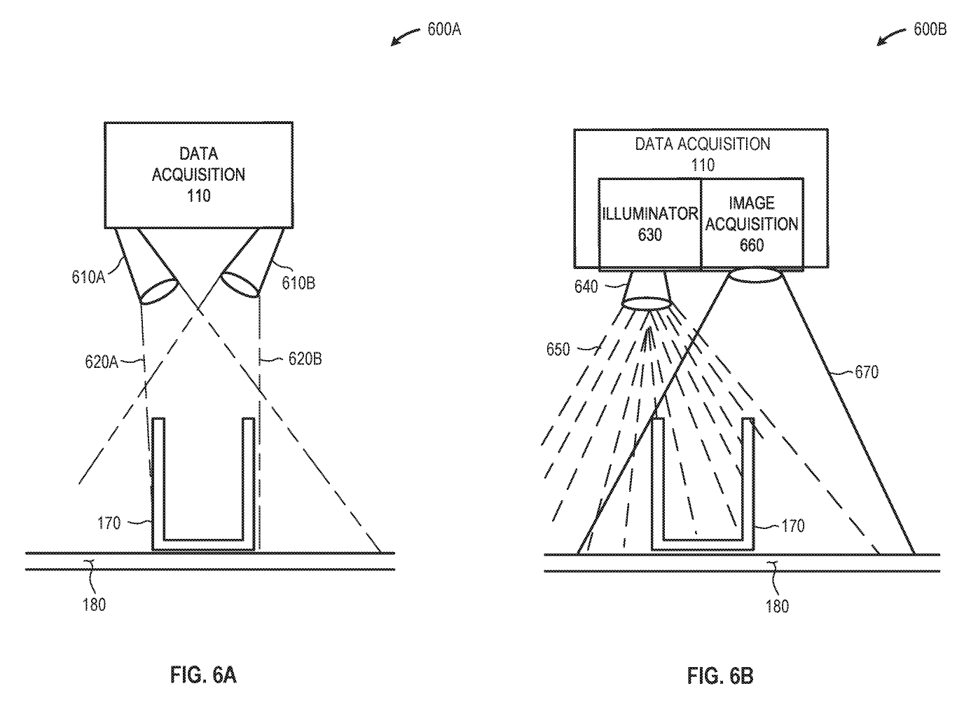

FIG. 6A is a schematic diagram of a system 600A that includes an illustrative data acquisition system 110 that uses a plurality of image acquisition devices 610A, 610B to capture a stereoscopic image of the container 170 from which three-dimensional model data may be extracted, in accordance with at least one embodiment described herein. FIG. 6B is a schematic diagram of a system 600B that includes an illustrative data acquisition system 110 that uses a structured light illuminator 630 and one or more image acquisition devices 660 from which three-dimensional model data may be extracted, in accordance with at least one embodiment described herein.

Referring to FIG. 6A, the stereoscopic data acquisition system 110 may include a first image acquisition device 610A and a second image acquisition device 610B (collectively, “image acquisition devices 610”) that capture images of the container 170 from a variety of angles to produce a stereoscopic image of the container 170. The container 170 is positioned within a first field-of-view 620A of the first image acquisition device 610A and within a second field-of-view 620B of the second image acquisition device 610B. In some implementations, the image acquisition devices 610 may be disposed in fixed locations and the container 170 may be transported by conveyance 180 past the image acquisition devices 610. In other implementations, the image acquisition devices 610 may be moveable and the container 170 may be in a fixed location such that the image acquisition devices 610 capture images of the container 170 from a variety of different angles. The stereoscopic data acquisition system 110 analyzes the differences between the images captured by the first image acquisition device 610A and the second image acquisition device 610B to determine the distance or location of each point on the surface of the container 170.

The image acquisition devices 610 may include one or more digital image acquisition devices, such as a charge coupled device (CCD) image acquisition device or a complementary metal oxide semiconductor (CMOS) image acquisition device. The image acquisition devices 610 may have any resolution, with image acquisition devices having greater resolution providing greater accuracy in the three-dimensional model of the container 170. Each of the image acquisition devices 610 may have a resolution of greater than about: about 1 megapixel; about 5 megapixels; about 10 megapixels; about 20 megapixels; or about 30 megapixels.

Referring now to FIG. 6B, the structured light data acquisition system 110 may include at least one structured light illuminator 630 and at least one image acquisition device 660. The structured light illuminator 630 may include at least one structured light projector 640 that projects a structured light pattern 650 on and/or across the container 170. The container 170 is positioned within the field-of-view 670 of the at least one image acquisition device 660. The image acquisition device 660 captures data representative of an image of the container 170 with the structured light pattern on or across the surfaces of the container 170. The structured light data acquisition system 110 analyzes the deformation of the structured light pattern across the surfaces of the container 170. The deformation in the structured light pattern permits the structured light data acquisition system 110 to determine the distance or location of each point on the surface of the container 170.

In embodiments, the structured light data acquisition system 110 may employ a laser interference method to generate a three-dimensional model of the container 170. In such a structured light data acquisition system 110, the structured light illuminator 630 may include a plurality of laser devices, each capable of producing a wide laser bean front that is swept across the container.

In embodiments, the illuminator 630 used in the structured light data acquisition system 110 may employ one or more structured light projectors 640. The structured light projection method uses incoherent light and generates a pattern by passing light through a spatial light modulator. The spatial light modulator may include, but is not limited to, a transmissive liquid crystal modulator, a reflective liquid crystal on silicon (LCOS) modulator, or a digital light processing (DLP; moving micro mirror) modulator.

The image acquisition device 660 may include one or more digital image acquisition devices, such as a charge coupled device (CCD) image acquisition device or a complementary metal oxide semiconductor (CMOS) image acquisition device. The image acquisition device may have nay resolution, with image acquisition devices having greater resolution providing greater accuracy in the three-dimensional model of the container 170. The image acquisition device 660 may have a resolution of greater than about: about 1 megapixel; about 5 megapixels; about 10 megapixels; about 20 megapixels; or about 30 megapixels.

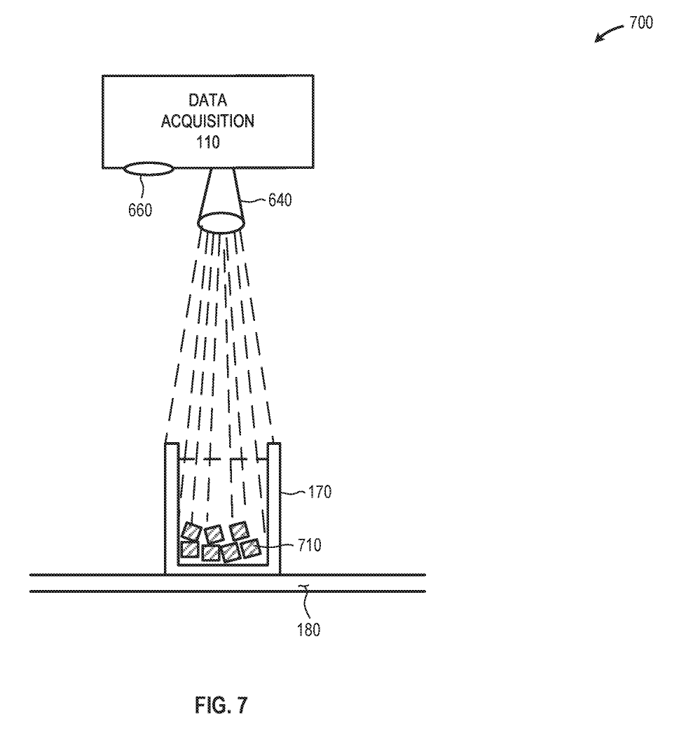

FIG. 7 depicts a system 700 that includes an illustrative structured light data acquisition system 110 capable of including one or more objects 710 disposed in the container 170 in the three-dimensional model data provided to the dimensioning circuitry 120, in accordance with at least one embodiment described herein. As depicted in FIG. 7, the data acquisition system 110 may include objects 710, such as ice cubes, placed in the container 170 in the three-dimensional model of the container 170. Such beneficially prevents overfilling of the container 170 due to the volume loss attributable to the one or more objects 710 disposed in the container 170 prior to commencing dispensing of material into the container. For example, a container 170 such as a shipping box may contain an object 710 for shipment. The object 710 may occupy a significant portion of the container 170. If the automated filling system 100 neglected to account for the volume occupied by the object 710 in the container 170 and instead dispensed packing material based on the available internal volume of the container 170, the packing material would overflow the container 170. The capability for the data acquisition system 110 to detect the presence of such objects 710 and include the volume occupied by objects placed in the container beneficially minimizes the likelihood of such an overflow as material is dispensed into the container 170.

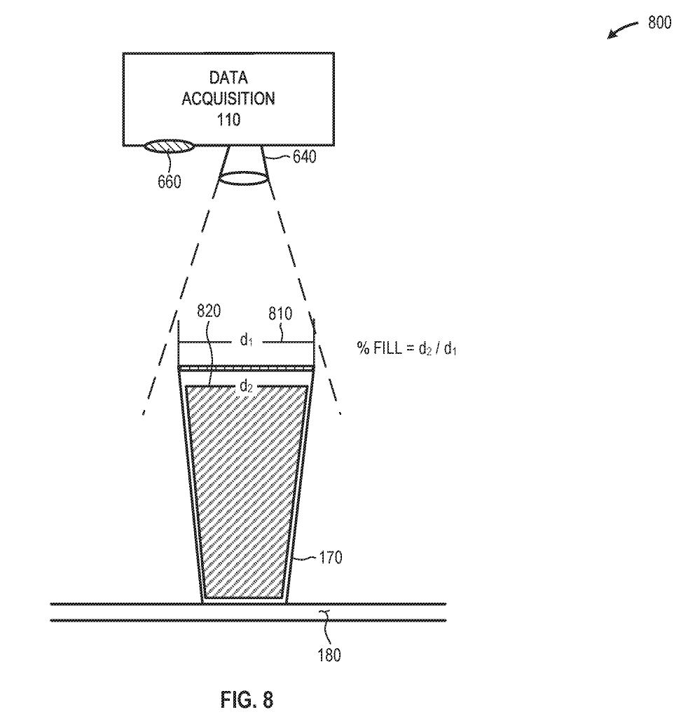

FIG. 8 depicts a system 800 that includes an illustrative structured light data acquisition system 110 capable of detecting a level in a container 170, in accordance with at least one embodiment described herein. The system 800 may be used in conjunction with any of the automated filling systems described in FIGS. 1 through 7. As depicted in FIG. 8, a structured light data acquisition system 110 may obtain a first diameter (d₁) 810 of the open end of container 170 and may also obtain a second diameter (d₂) 820 of the liquid level as liquid is dispensed into the container 170. Comparing the second diameter 820 with the first diameter 810 provides an indication of the level in the container 170. In such an embodiment, the structured light data acquisition system 110 may cease dispensing liquid into the container 170 when the liquid level reaches a defined second diameter 820.

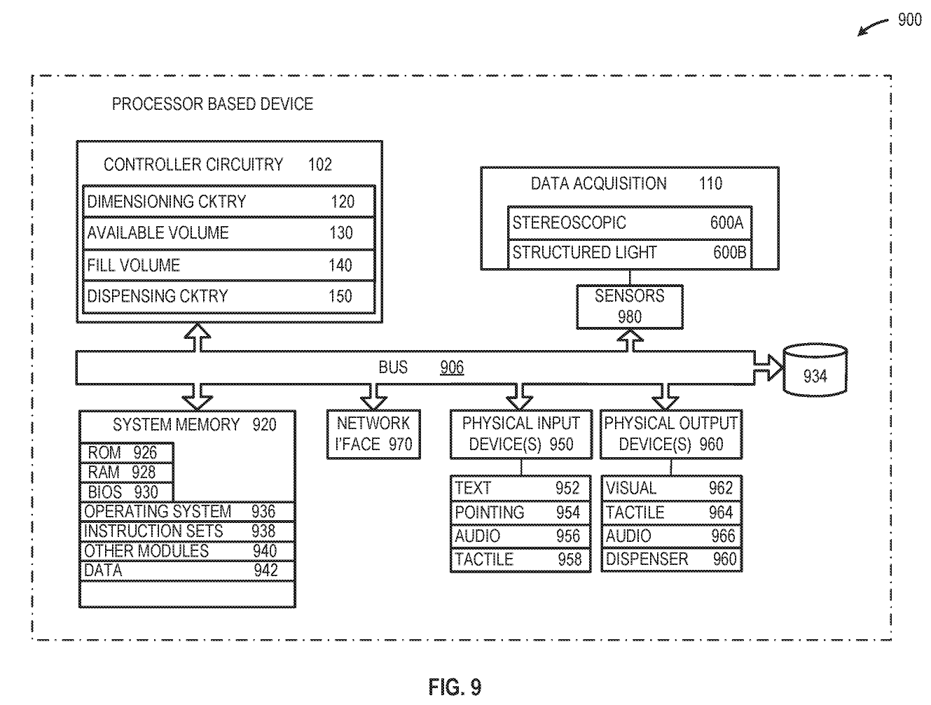

FIG. 9 is a block diagram of an illustrative processor based device 900 that includes an automated filling system such as depicted in FIGS. 1 through 8, in accordance with at least one embodiment described herein. The following discussion provides a brief, general description of the components forming an illustrative processor based device 900 that includes an automated filling system using one or more of: logic devices, logic systems, logic elements, and/or controller circuitry 102 capable of providing dimensioning circuitry 120, available volume determination circuitry 130, fill volume determination circuitry 140, dispensing circuitry 150, and one or more dispensers 160.

At least some embodiments or implementations may include machine-readable or computer-executable instruction sets, such as program application modules, objects, or macros being executed by the controller circuitry 102. At least some embodiments or implementations may include circuitry implemented in the form of hard-wired circuitry and components, semiconductor circuitry, logic systems, logic elements, logic devices, logic modules, logic systems/sub-systems, microprocessors, controllers, or similar devices that provide the various components, systems, sub-systems, or modules included in processor based device 900.

Those skilled in the relevant art will appreciate the illustrated embodiments as well as other embodiments may be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. Program modules may be disposed in both local and remote memory storage devices in a distributed computing environment.

The processor based device 900 may include controller circuitry 102 that includes a variety of electronic and/or semiconductor components that are disposed at least partially within a personal computer, blade server, workstation, rack mount blade server, or other similar current or future processor-based devices and/or systems capable of executing machine-readable instructions. The controller circuitry 102 may be interconnected with, electrically coupled, and/or communicably coupled to various components within the illustrative processor based device 900 via one or more serial or parallel conductors, pathways, or buses 906. As depicted in FIG. 9, all or a portion of the controller circuitry 102 may be apportioned or allocated to providing, forming, or otherwise producing all or a portion of the dimensioning circuitry 120, available volume determination circuitry 130, fill volume determination circuitry 140, and dispensing circuitry 150.

As depicted in FIG. 9, system components such as the system memory 920 may be communicably coupled to the controller circuitry 102 via the bus 906. The processor based device 900 may, at times, be referred to in the singular herein, but this is not intended to limit the embodiments to a single system, since in certain embodiments, there will be more than one processor based device 900, networked processor based devices 900, client/server processor based devices 900, or other networked systems, circuits, or devices included.

The controller circuitry 102 may include any number, type, or combination of conductors, insulators, electrical devices, and/or semiconductor components. At times, the controller circuitry 102 may be implemented in whole or in part in the form of semiconductor devices such as diodes, transistors, inductors, capacitors, and resistors. Such an implementation may include, but is not limited to any current or future developed single- or multi-core processor or microprocessor, such as: one or more systems on a chip (SOCs); one or more central processing units (CPUs); one or more digital signal processors (DSPs); one or more graphics processing units (GPUs); one or more application-specific integrated circuits (ASICs), one or more field programmable gate arrays (FPGAs), and the like. Unless described otherwise, the construction and operation of the various blocks shown in FIG. 9 are of conventional design. Consequently, such blocks need not be described in further detail herein, as they will be understood by those skilled in the relevant art. The bus 906 that interconnects at least some of the components may employ any known serial or parallel bus structures or architectures.

The system memory 920 may include read-only memory (“ROM”) 926 and random access memory (“RAM”) 928 in any number, capacity, and/or configuration. A portion of the ROM 926 may contain a basic input/output system (“BIOS”) 930. The BIOS 930 may provide basic functionality to the processor based device 900. For example, by causing the controller circuitry 102 to load one or more machine-readable instruction sets that cause the all or a portion of the controller circuitry 102 to provide and function as the dimensioning circuitry 120, available volume determination circuitry 130, fill volume determination circuitry 140, and dispensing circuitry 150. The system memory 920 may also include one or more other instruction sets 940 useful for providing one or more functional aspects of the processor based device 900. The system memory 920 may also include one or more application specific instruction sets 942, such as one or more spreadsheet, word processing, e-mail, or similar programs. The system memory 920 may also include information and/or data associated with an operating system 944 used to boot or otherwise initiate operation of the processor based device 900.

The processor based device 900 may include one or more communicably coupled, non-transitory, data storage devices 934. The one or more data storage devices 934 may include any number and/or combination of any current or future developed non-transitory storage devices and/or memory. Non-limiting examples of such non-transitory, data storage devices 934 may include, but are not limited to, one or more magnetic storage devices, one or more optical storage devices, one or more solid-state electromagnetic storage devices, one or more electroresistive storage devices, one or more molecular storage devices, one or more quantum storage devices, or various combinations thereof. In some implementations, the data storage devices 934 may be disposed remote from the processor based device 900. In some implementations, the data storage devices 934 may include one or more hot-pluggable or removable data storage devices.

One or more interfaces and/or controllers (not shown in FIG. 9) may communicably couple the one or more storage devices 934 to the bus 906. The one or more storage devices 934 may contain machine-readable instruction sets, data structures, program modules, and other data useful to the data acquisition system 100, the dimensioning circuitry 120, the available volume determination circuitry 130, the fill volume determination circuitry 140, and the dispensing circuitry 150.

The processor based device 900 may include any number or combination of sensors 980 capable of providing three-dimensional model data of at least the container 170 placed or otherwise disposed in, on, or about the automated filling system provided by the processor based device 900. In some implementations, such sensors 980 may include a data acquisition system 110 that includes a stereoscopic three-dimensional scanner 600A and/or includes a structured light three-dimensional scanner 600B. In embodiments, the stereoscopic three-dimensional scanner 600A may include a plurality of image sensors (e.g., one or more charge coupled device (CCD) or complementary metal oxide semiconductor (CMOS) image sensors, or similar) capable of providing a stereoscopic image of the container 170 from which three-dimensional model data may be generated by the data acquisition system 110. In other embodiments, the structured light three-dimensional scanner 600B may include one or more structured light illuminators 630 (e.g., planar laser illuminators, pseudo-random pattern structured light, patterned structured light, and similar) and one or more image sensors 660 (e.g., one or more charge coupled device (CCD) or complementary metal oxide semiconductor (CMOS) image sensors, or similar) capable of providing a stereoscopic image of the container 170 from which three-dimensional model data may be generated by the data acquisition system 110.

Machine-readable instruction sets and/or applications 938 may be stored or otherwise retained in whole or in part in the storage device 934 or in whole or in part, in system memory 920. Such instruction sets 938 may be transferred from one or more storage devices 934 and stored in the system memory 920 in whole or in part for execution by the controller circuitry 102. The machine-readable instruction sets 938 may include instructions and/or logic providing the automated filling methods described herein. For example, one or more applications 938 may cause the controller circuitry 102 to provide the dimensioning circuitry 120 and may cause the dimensioning circuitry 120 to determine one or more internal physical dimensions of the container 170 using a three-dimensional model of the container 170 generated by the data acquisition system 110. In some implementations, one or more applications 938 may cause the controller circuitry 102 to provide the dimensioning circuitry 120 and may cause the dimensioning circuitry 120 to slice, segment, or section the container 170 into a plurality of slices such that the available volume determination circuitry 130 is able to numerically integrate the slices.

The processor based device 900 may include one or more communicably coupled physical input devices 950, such as one or more text entry devices 952 (e.g., keyboard), one or more pointing devices 954 (e.g., mouse, trackball, touchscreen), one or more audio input devices 956 and/or one or more tactile input devices 958. In addition, the processor based device 900 may include any number of buttons, selectors, knobs, or similar single or multi-position devices to provide input to the controller circuitry 102. Such physical input devices 950 may be used, for example, to provide, enter, or otherwise supply commands (e.g., acknowledgements, selections, confirmations, and similar) as well as information (e.g., acknowledgements, and similar) to the processor based device 900.

The processor based device 900 may include one or more communicably coupled physical output devices 960, such as one or more visual output devices 962 (e.g., touchscreen; liquid crystal display (LCD) device; light emitting diode (LED) display, organic LED display, and similar), one or more audio output devices 964, one or more tactile output devices 966 (e.g., haptic feedback or similar), or combinations thereof. The processor based device 900 may also include an interface to the dispenser 160 used to dispense materials into the container 170. Such an interface may include a communications link, channel, or bus to communicate information and/or data indicative of a material selection to a dispenser 160 capable of dispensing a plurality of materials. Such an interface may include a communications link, channel, or bus to communicate one or more signals used to transition the dispenser 160 between an ON or OPERATING state during which material is dispensed to the container 170 and an OFF or STANDBY state during which no material is dispensed.

The semiconductor platform test system 100 may include one or more wired or wireless network interfaces 970 to provide communications capabilities with one or more additional external devices, systems, and/or services. In embodiments, the one or more network interfaces 970 may include one or more wireless interfaces, such as one or more IEEE 802.11 (WiFi®) compliant interfaces. In embodiments, the one or more network interfaces 970 may include one or more wired interfaces, such as one or more IEEE 802.3 (“Ethernet”) compliant interfaces.

The processor based device 900 includes one or more sensors 980, including the data acquisition system 110 used to create the three-dimensional model of the container 170. In embodiments, the data acquisition system 110 may include a stereoscopic data acquisition system 600A using multiple image acquisition devices to provide a stereoscopic image of the container 170 from which three-dimensional model data may be generated. In embodiments, the data acquisition system 110 may include a structured light data acquisition system 600B using a structured light illuminator 630 and one or more image acquisition devices 660. The structured light data acquisition system 600B analyzes the deviations present in the structured light pattern to generate the three-dimensional model of the container 170.

For convenience, the network interface 970, the controller circuitry 102, the system memory 920, the physical input devices 950 and the physical output devices 960 are illustrated as communicatively coupled to each other via the bus 906, thereby providing connectivity between the above-described components. In alternative embodiments, the above-described components may be communicatively coupled in a different manner than illustrated in FIG. 9. For example, one or more of the above-described components may be directly coupled to other components, or may be coupled to each other, via one or more intermediary components (not shown). In some embodiments, the bus 906 may be omitted and the components are coupled directly to each other using suitable wired or wireless connections.

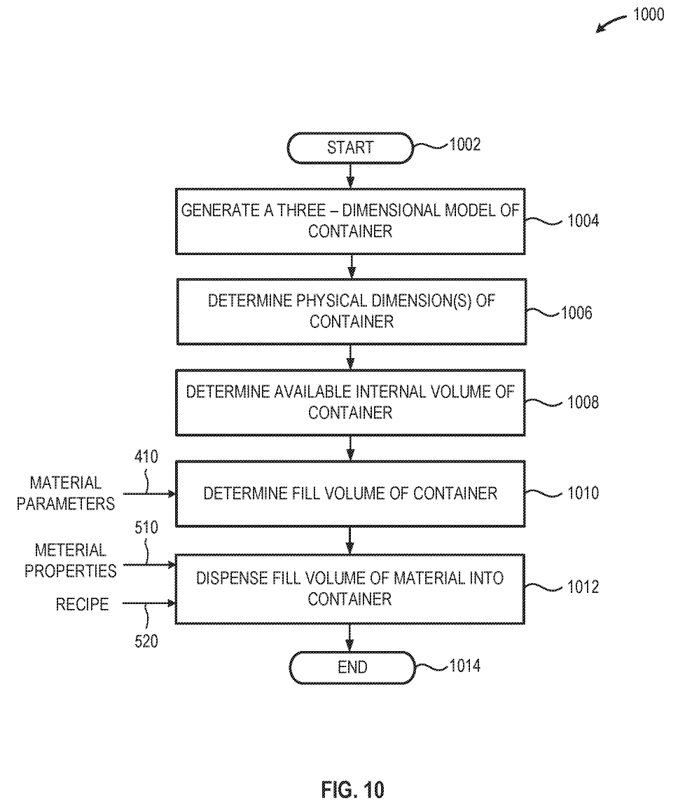

FIG. 10 is a high-level logic flow diagram of an illustrative method 1000 of generating a three-dimensional model of a container 170 and automatically dispensing material into the container 170 to determined fill volume determined based, at least in part, on the three-dimensional model, in accordance with at least one embodiment described herein. The method 1000 advantageously determines a fill volume for a container 170 based on an autonomously generated three-dimensional model of the container 170. A data acquisition system 110 employs a three-dimensional scanning technique (e.g., stereoscopic, structured light, laser, or similar) to generate a three-dimensional model. Fill volume circuitry determines an appropriate fill volume for the container based on the internal physical dimensions of the container and the physical properties of the material used to fill the container 170. The method 1000 accommodates recipes in which multiple materials are dispensed to the container in defined quantities or proportions. The method 1000 does not require the use of standard size (small, medium, large, etc.) or specialty (e.g., containers with magnets, floats, RFID tags, or other level indicting devices) and instead beneficially fills containers 170 having any size, shape or configuration based on an accurate determination of the internal physical volume within the container 170. The method 1000 does not monitor level during filling and instead determines an accurate fill volume prior to dispensing material into the container 170. The method 1000 commences at 1002.

At 1004, the data acquisition system 110 generates a three-dimensional model of a container 170. The data acquisition system 110 may include any number or combination of systems and/or devices capable of generating information and/or data in the form of a three-dimensional model of an object such as the container 170. In embodiments, the data acquisition system 110 may include a stereoscopic data acquisition system 600A. In embodiments, the data acquisition system 110 may include a structured light data acquisition system 600B.

Advantageously, the three-dimensional model includes any objects (e.g., ice cubes) present in the container 170. The data acquisition system 110 generates an output signal 210 that includes information and/or data representative of a three-dimensional model of the container 170.

At 1006, using the three-dimensional information and/or data received from the data acquisition system 110, dimensioning circuitry 120 determines one or more internal physical dimensions of the container 170. The number of internal physical dimensions determined by the dimensioning circuitry 120 may vary based upon the physical configuration of the container 170. Containers having a standard shape (hollow cylinder, hollow conical frustum, sphere, etc.) may require fewer internal physical dimensions than containers having an irregular shape (e.g., a Smokey the Bear mug). In embodiments, the dimensioning circuitry 130 may section, slice, or segment the internal physical space of the container 170 into a plurality of slices, each having a logically associated set of physical dimensions. The internal physical dimensions generated by the dimensioning circuitry 120 include any objects, such as ice cubes, that disposed within the container 170. The dimensioning circuitry 120 generates an output signal 220 that includes information and/or data representative of the determined internal physical dimensions of the container 170.

At 1008, using the internal physical dimension information and/or data received from the dimensioning circuitry 120, available volume circuitry 130 determines the available internal physical volume of the container 170. In embodiments, the available volume circuitry 130 may retrieve one or more formulae if the internal physical volume of the container 170 is determinable using the retrieved one or more formulae. In embodiments, the available volume circuitry 130 may numerically integrate the volume associated with each respective one of a plurality of slices of the internal physical volume of the container 170. The available volume circuitry 130 generates an output signal 310 that includes information and/or data representative of the available internal volume of the container 170.

At 1010, using the available internal volume information and/or data received from the available volume circuitry 130, fill volume circuitry 140 determines the fill volume for the container 170. The fill volume logically associated with a container 170 may be based on the available internal volume of the container 170 and one or more signals 410 that includes information and/or data representative of material parameters associated with the material dispensed to the container 170. Such material parameters may include, but are not limited to: the temperature of the material and the propensity of the material to foam upon dispensing. For example, a container 170 having an available internal volume of 1000 cubic centimeters (cm³) may be filled with a cold liquid to a level of 90% (900 cm³) and may be filled with a hot liquid to a level of 80% (800 cm³) to minimize the possibility of splashing of the hot liquid from the container. In another example, a container 170 having an available internal volume of 1000 cubic centimeters (cm³) may be filled with a liquid that foams upon dispensing (e.g., beer, soft drink). To allow for the formation of a foam head within the container 170, the container may be filled (i.e., the fill volume circuitry 140 may determine a fill volume) to a level of 80% (800 cm³). The fill volume circuitry 140 generates an output signal 420 that includes information and/or data representative of the fill volume of the container 170.

At 1012, using the fill volume information and/or data received from the fill volume circuitry 120, dispensing circuitry 150 causes a dispenser 160 to dispense one or more materials to the container 170. In embodiments, the dispensing circuitry 150 may receive a signal 510 that includes information and/or data representative of one or more recipes using a plurality of materials. Such recipes may include information and/or data representative of the proportions of materials to dispense to the container 170. The dispensing circuitry 150 generates a first output signal 520 that includes information and/or data representative of a material selection from the plurality of materials. The dispensing circuitry 150 generates a second output signal 530 that transitions the dispenser 160 between a first, ON or ACTIVE state and a second, OFF or STANDBY state. The dispensing circuitry 150 communicates the first output signal 520 and the second output signal 530 to the dispenser 160. The method 1000 concludes at 1014.

While FIG. 10 illustrates various operations according to one or more embodiments, it is to be understood that not all of the operations depicted in FIG. 10 are necessary for other embodiments. Indeed, it is fully contemplated herein that in other embodiments of the present disclosure, the operations depicted in FIG. 10, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), rewritable compact disks (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to systems and methods for automated generation of a three-dimensional model of a container prior to dispensing material into the container. Using the three-dimensional model of the container, the systems and methods determine an available internal volume of the container and a fill volume of the container that takes into consideration one or more material parameters, such as material temperature. Using the determined fill volume, the systems and methods dispense one or more materials into the container to the determined fill volume. Where a plurality of materials are dispensed, the systems and methods may use a recipe to determine appropriate volumes of each of a plurality of materials to dispense to the container to provide the determined fill volume. Such systems and methods beneficially account for objects present in the container prior to dispensing materials into the container.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for automatically generating a three-dimensional model of a container and determining a fill volume for the container based on the generated three-dimensional model.

According to example 1, there is provided an automated dispensing system. The system may include: a data acquisition system to obtain a three-dimensional model of a container; dimensioning circuitry to determine at least one physical dimension of the container using the three-dimensional model of the container; available internal volume circuitry to determine an available internal volume of the container based, at least in part on the at least one detected physical dimension of the container; fill volume circuitry to determine a fill volume to provide a defined fill level within the container based on the determined available internal volume of the container; and dispensing circuitry to dispense the fill volume of at least one material into the container.

Example 2 may include elements of example 1 and the system may additionally include: a liquid dispensing system communicably coupled to the dispensing circuitry, the dispensing circuitry to cause the liquid dispensing system to dispense the determined fill volume of at least one liquid into the container.

Example 3 may include elements of example 2 where the fill volume circuitry accounts for a volume loss in the container when determining the fill volume, the volume loss attributable, at least in part, to a volume occupied by one or more objects in the container.

Example 4 may include elements of example 2 where using a defined recipe, the dispensing circuitry further determines a respective volume of each of a plurality of liquids to dispense into the container; and where the total of the respective determined volumes of each of the plurality of liquids provides the determined fill volume.

Example 5 may include elements of example 4 where the fill volume circuitry accounts for a volume loss in the container when determining the fill volume, the volume loss attributable, at least in part, to a volume occupied by one or more objects in the container.

Example 6 may include elements of example 1, and the system may additionally include: a solid material dispensing system communicably coupled to the dispensing circuitry, the dispensing circuitry to cause the solid material dispensing system to dispense the fill volume of at least one solid material into the container.

Example 7 may include elements of example 6 where the fill volume circuitry accounts for a volume loss in the container when determining the fill volume, the volume loss in the container attributable, at least in part, to one or more objects present in the container.

Example 8 may include elements of example 6 where the fill volume circuitry accounts for a void space present in the at least one solid materials dispensed into container when determining the fill volume.

Example 9 may include elements of example 8 where the dispensing circuitry further determines each of a plurality of solid materials to add to the container, the plurality of solid materials dispensed in defined proportions to provide the fill volume.

Example 10 may include elements of example 1 where the container comprises a closed bottom hollow vessel in the form of an inverted conical frustum having a smaller diameter closed end and a larger diameter open end; and where the fill volume circuitry determines the fill volume to achieve a desired ratio of a detected diameter of a liquid level within the container to an end diameter of the larger diameter open end of the container.

Example 11 may include elements of example 1, and the system may additionally include a container detection circuitry to autonomously detect the container; where the fill volume circuitry autonomously determines the fill volume of the container upon autonomous detection of the container by the container detection circuitry.

Example 12 may include elements of any of examples 1 through 11 where the data acquisition system comprises a stereoscopic data acquisition system that includes a plurality of image acquisition devices arranged to provide a stereoscopic image of the container.

Example 13 may include elements of any of examples 1 through 11 where the data acquisition system comprises a structured light data acquisition system that includes a structured light illuminator communicably coupled to at least one image acquisition device.

Example 14 may include elements of example 13, and the system may additionally include a container conveying system to displace the container at least partially through the structured light pattern produced by the structured light data acquisition system.

Example 15 may include elements of example 13 where the structured light illuminator produces at least one of: a uniform dot pattern; a random dot pattern; a uniform stripe pattern; or a random stripe pattern.

Example 16 may include elements of example 13 where the structured light illuminator generates an output in a visible electromagnetic spectrum of 390 nanometers (nm) to 700 nm and the at least one image acquisition device includes an image acquisition device sensitive to the visible electromagnetic spectrum.

Example 17 may include elements of example 13 where the structured light illuminator generates an output in the infrared light electromagnetic spectrum above 700 nm and the at least one image acquisition device includes an infrared image acquisition device.

According to example 18, there is provided an automated dispensing method. The method may include: generating a three-dimensional model of a container using a data acquisition system; determining, by dimensioning circuitry, at least one physical dimension of the container using the generated three-dimensional model; determining, by available internal volume circuitry, an available internal volume of the container using the at least one determined physical dimension of the container; determining, by fill volume circuitry, a fill volume to provide a defined fill level within the container based on the available internal volume of the container; and dispensing, by dispensing circuitry, the fill volume of at least one material into the container.

Example 19 may include elements of example 18 where dispensing the fill volume of at least one material into the container may include causing, by the dispensing circuitry, a communicably coupled liquid dispensing system to dispense the fill volume of at least one liquid into the container.

Example 20 may include elements of example 19, and the method may additionally include: determining, by the available internal volume circuitry, an available internal volume that accounts for a volume loss in the container attributable, at least in part, to one or more objects present in the container.

Example 21 may include elements of example 20, and the method may additionally include: determining, by the dispensing circuitry, a respective volume of each of a plurality of liquids to dispense to the container, wherein the total of the respective determined volumes of each of the plurality of liquids provides the determined fill volume.

Example 22 may include elements of example 20 where determining an available internal volume that accounts for a volume loss in the container attributable, at least in part, to one or more objects deposited in the container may include: determining, by the available internal volume circuitry, an available internal volume that accounts for a volume loss in the container attributable, at least in part, to one or more ice cubes present in the container.

Example 23 may include elements of example 18 where dispensing the fill volume of at least one material into the container, further may include: causing, by the dispensing circuitry, a communicably coupled solid material dispensing system to dispense the fill volume of at least one solid material into the container.

Example 24 may include elements of example 23, and the method may additionally include: determining, by the available internal volume circuitry, an available internal volume that accounts for a volume loss in the container attributable, at least in part, to one or more objects present in the container.

Example 25 may include elements of example 23, and the method may additionally include: determining, by the fill volume circuitry, a fill volume that accounts for a void space present in the at least one solid materials dispensed into container when determining the fill volume.

Example 26 may include elements of example 25, and the method may additionally include: determining, by the dispensing circuitry, a volume of each of a plurality of solid materials to add to the container, the volume of each of the plurality of solid materials dispensed in defined proportions to provide the fill volume.

Example 27 may include elements of example 18 where determining a fill volume to provide a defined fill level within the container based on the determined available internal volume in the container may further include: determining, by fill volume circuitry, a fill volume to achieve a desired ratio of a detected diameter of a liquid level within the container to an end diameter of a larger diameter open end of the container, wherein the container comprises a vessel in the form of an inverted conical frustum having a smaller diameter closed end and a larger diameter open end.

Example 28 may include elements of example 18, and the method may additionally include: autonomously detecting the container by container detection circuitry; and autonomously determining, by the fill volume circuitry, the fill volume of the container responsive to the autonomous detection of the container by the container detection circuitry.

Example 29 may include elements of example 18 where generating a three-dimensional model of a container may further include: generating a three-dimensional model of a container using a stereoscopic data acquisition system that includes a plurality of image acquisition devices arranged to provide a stereoscopic image of the container.

Example 30 may include elements of any of examples 18 through 29 where generating a three-dimensional model of a container may further include: generating a three-dimensional model of a container using a structured light data acquisition system that includes a structured light illuminator communicably coupled to at least one image acquisition device.

Example 31 may include elements of example 30, and the method may additionally include: displacing, by a conveyance system, the container at least partially through the structured light pattern produced by the structured light data acquisition system.

Example 32 may include elements of example 30 where generating a three-dimensional model of a container using a structured light data acquisition system may further include: generating a three-dimensional model of a container using a structured light data acquisition system that includes a structured light illuminator that produces at least one of: a uniform dot pattern; a random dot pattern; a uniform stripe pattern; or a random stripe pattern.

Example 33 may include elements of example 30 where generating a three-dimensional model of a container using a structured light data acquisition system may further include: generating a three-dimensional model of a container using a structured light data acquisition system that includes a structured light illuminator that generates an output in a visible electromagnetic spectrum of 390 nanometers (nm) to 700 nm; and acquiring an image of the illuminated container using at least one image acquisition device sensitive to the visible electromagnetic spectrum.

Example 34 may include elements of example 30 where generating a three-dimensional model of a container using a structured light data acquisition system may further include: generating a three-dimensional model of a container using a structured light data acquisition system that includes a structured light illuminator that generates an output in an infrared electromagnetic spectrum above 700 nm; and acquiring an image of the illuminated container using at least one image acquisition device sensitive to the infrared electromagnetic spectrum.

According to example 35, there is provided a non-transitory machine-readable storage medium containing instructions that, when executed, cause controller circuitry to: cause a data acquisition system to generate a three-dimensional model of a container; cause dimensioning circuitry to determine a at least one internal physical dimension of the container based, at least in part, on the three-dimensional model of the container; cause available internal volume circuitry to determine an available internal volume of the container using the at least one internal physical dimension of the container; cause fill volume circuitry to determine a fill volume to provide a defined fill level within the container based on the available internal volume in the container; and cause dispensing circuitry to dispense the fill volume of at least one material into the container.

Example 36 may include elements of example 35 where the instructions that cause the dispensing circuitry to dispense the fill volume of at least one material into the container, may further cause the dispensing circuitry to: cause a communicably coupled liquid dispensing system to dispense the fill volume of at least one liquid into the container.

Example 37 may include elements of example 36 where the machine-readable instructions may further cause the available internal volume circuitry to: determine an available internal volume that accounts for a volume loss in the container attributable, at least in part, to a presence of one or more objects disposed in the container.

Example 38 may include elements of example 37 where the machine-readable instructions may further cause the dispensing circuitry to: determine, using the dispensing circuitry, a respective volume of each of a plurality of liquids to dispense to the container, wherein the total of the respective determined volumes of each of the plurality of liquids provides the determined fill volume.

Example 39 may include elements of example 37 where the machine-readable instructions that cause the available internal volume circuitry to determine an available internal volume that accounts for a volume loss in the container attributable, at least in part, to one or more objects present in the container may further cause the available internal volume circuitry to: determine a volume loss in the container attributable, at least in part, to one or more ice cubes present in the container.

Example 40 may include elements of example 35 where the machine-readable instructions that cause the dispensing circuitry to dispense the fill volume of at least one material into the container, may further cause the dispensing circuitry to: cause a communicably coupled solid material dispensing system to dispense the fill volume of at least one solid material into the container.

Example 41 may include elements of example 40 where the machine-readable instructions may further cause the available internal volume circuitry to: determine, an available internal volume that accounts for a volume loss in the container attributable, at least in part, to a presence of one or more objects disposed in the container.

Example 42 may include elements of example 40 where the machine-readable instructions may further cause the fill volume circuitry to: determine a fill volume that accounts for a void space present in the at least one solid materials dispensed into container when determining the fill volume.

Example 43 may include elements of example 42 where the machine-readable instructions may further cause the dispensing circuitry to: determine a volume of each of a plurality of solid materials to add to the container, the volume of each of the plurality of solid materials dispensed in defined proportions to provide the determined fill volume.

Example 44 may include elements of example 35 where the machine-readable instructions may further cause the controller circuitry to: cause container detection circuitry to autonomously detect a presence of the container; and cause the fill volume circuitry to autonomously determine the fill volume of the container responsive to the autonomous detection of the container by the container detection circuitry.

Example 45 may include elements of any of examples 35 through 44 where the machine-readable instructions that cause the data acquisition system to generate a three-dimensional model of a container may further cause the data acquisition system to: generate a three-dimensional model of the container using a stereoscopic data acquisition system that includes a plurality of image acquisition devices arranged to provide a stereoscopic image of the container.

Example 46 may include elements of any of examples 35 through 44 where the machine-readable instructions that cause the data acquisition system to generate a three-dimensional model of a container may further cause the data acquisition system to: generate a three-dimensional model of the container using a structured light data acquisition system that includes a structured light illuminator communicably coupled to at least one image acquisition device.

Example 47 may include elements of example 46 where the machine-readable instructions may further cause the controller circuitry to: displace, using a conveyance system, the container at least partially through the structured light pattern produced by the structured light data acquisition system.

Example 48 may include elements of example 46 where the machine-readable instructions that cause the structured light data acquisition system to generate a three-dimensional model of a container may further cause the structured light data acquisition system to: generate a three-dimensional model of the container using a structured light illuminator that produces at least one of: a uniform dot pattern; a random dot pattern; a uniform stripe pattern; or a random stripe pattern.

Example 49 may include elements of example 46 where the machine-readable instructions that cause the structured light data acquisition system to generate a three-dimensional model of a container may further cause the structured light data acquisition system to: generate a three-dimensional model of the container using a structured light data acquisition system that includes a structured light illuminator that generates an output in a visible electromagnetic spectrum of 390 nanometers (nm) to 700 nm; and acquire an image of the illuminated container using at least one image acquisition device sensitive to the visible electromagnetic spectrum.

Example 50 may include elements of example 46 where the machine-readable instructions that cause the structured light data acquisition system to generate a three-dimensional model of a container may further cause the structured light data acquisition system to: generate a three-dimensional model of the container using a structured light data acquisition system that includes a structured light illuminator that generates an output in an infrared electromagnetic spectrum above 700 nm; and acquire an image of the illuminated container using at least one image acquisition device sensitive to the infrared electromagnetic spectrum.

According to example 51, there is provided an automated dispensing system. The system may include: a means for generating a three-dimensional model of a container; a means for determining at least one physical dimension of the container using the generated three-dimensional model; a means for determining an available internal volume of the container using the at least one determined physical dimension of the container; a means for determining a fill volume to provide a defined fill level within the container based on the available internal volume of the container; and a means for dispensing the fill volume of at least one material into the container.

Example 52 may include elements of example 51 where the means for dispensing the fill volume of at least one material into the container may further include: a means for causing a communicably coupled liquid dispensing system to dispense the fill volume of at least one liquid into the container.

Example 53 may include elements of example 51, and the system may additionally include: a means for determining an available internal volume that accounts for a volume loss in the container attributable, at least in part, to a presence of one or more objects disposed in the container.

Example 54 may include elements of example 53, and the system may additionally include: a means for determining a respective volume of each of a plurality of liquids to dispense to the container, wherein the total of the respective determined volumes of each of the plurality of liquids provides the determined fill volume.

Example 55 may include elements of example 53 where the means for determining an available internal volume that accounts for a volume loss in the container attributable, at least in part, to one or more objects deposited in the container may additionally include: a means for determining an available internal volume that accounts for a volume loss in the container attributable, at least in part, to one or more ice cubes present in the container.

Example 56 may include elements of example 51 where the means for dispensing the fill volume of at least one material into the container, may further include: a means for causing a communicably coupled solid material dispensing means to dispense the fill volume of at least one solid material into the container.

Example 57 may include elements of example 56, and the system may additionally include: a means for determining an available internal volume that accounts for a volume loss in the container attributable, at least in part, to a presence of one or more objects disposed in the container.

Example 58 may include elements of example 56, and the system may additionally include: a means for determining a fill volume that accounts for a void space present in the at least one solid materials dispensed into container when determining the fill volume.

Example 59 may include elements of example 58, and the system may additionally include: a means for determining a volume of each of a plurality of solid materials to add to the container, the volume of each of the plurality of solid materials dispensed in defined proportions to provide the fill volume.

Example 60 may include elements of example 51 where the means for determining a fill volume to provide a defined fill level within the container based on the determined available internal volume in the container may further include: a means for determining a fill volume to achieve a desired ratio of a detected diameter of a liquid level within the container to an end diameter of a larger diameter open end of the container, wherein the container comprises a vessel in the form of an inverted conical frustum having a smaller diameter closed end and a larger diameter open end.

Example 61 may include elements of example 51, and the system may additionally include: a means for autonomously detecting a presence of the container; and a means for autonomously determining the fill volume of the container responsive to the autonomous detection of the container by the container detection circuitry.

Example 62 may include elements of any of examples 51 through 62, where the means for generating a three-dimensional model of a container may further include: a means for generating a three-dimensional model of a container using a plurality of image acquisition devices arranged to provide a stereoscopic image of the container.

Example 63 may include elements of any of examples 51 through 62, where the means for generating a three-dimensional model of a container may further include: a means for generating a three-dimensional model of a container using a structured light illuminator communicably coupled to at least one image acquisition device.

Example 64 may include elements of example 63, and the system may additionally include: a means for displacing the container at least partially through a structured light pattern.

Example 65 may include elements of example 63 where the means for generating a three-dimensional model of a container may further include: a means for generating a three-dimensional model of a container using a structured light illuminator that produces at least one of: a uniform dot pattern; a random dot pattern; a uniform stripe pattern; or a random stripe pattern.

Example 66 may include elements of example 63 where the means for generating a three-dimensional model of a container may further include: a means for generating a three-dimensional model of a container using a structured light illuminator that generates an output in a visible electromagnetic spectrum of 390 nanometers (nm) to 700 nm; and a means for acquiring an image of the illuminated container using at least one image acquisition device sensitive to the visible electromagnetic spectrum.

Example 67 may include elements of example 63 where the means for generating a three-dimensional model of a container may further include: a means for generating a three-dimensional model of a container using a structured light illuminator that generates an output in an infrared electromagnetic spectrum above 700 nm; and a means for acquiring an image of the illuminated container using at least one image acquisition device sensitive to the infrared electromagnetic spectrum.

According to example 68, there is provided a system to automatically fill a container, the system being arranged to perform the method of any of examples 18 through 34.

According to example 69, there is provided a chipset arranged to perform the method of any of examples 18 through 34.

According to example 70, there is provided a non-transitory machine readable medium comprising a plurality of instructions that, in response to be being executed on a computing device, cause the computing device to carry out the method according to any of examples 18 through 34.

According to example 71, there is provided a device configured to automatically fill a container, the device being arranged to perform the method of any of examples 18 through 34. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. An automated dispensing system, comprising:
a data acquisition system to obtain a three-dimensional model of a container;
dimensioning circuitry to determine at least one physical dimension of the container using the three-dimensional model of the container;
available internal volume circuitry to determine an available internal volume of the container based, at least in part on the at least one detected physical dimension of the container;
fill volume circuitry to determine a fill volume to provide a defined fill level within the container based on the determined available internal volume of the container; and
dispensing circuitry to dispense the fill volume of at least one material into the container.

2. The system of claim 1, further comprising:
a liquid dispensing system communicably coupled to the dispensing circuitry, the dispensing circuitry to cause the liquid dispensing system to dispense the determined fill volume of at least one liquid into the container.

3. The system claim 2 wherein the fill volume circuitry accounts for a volume loss in the container when determining the fill volume, the volume loss attributable, at least in part, to a volume occupied by one or more objects in the container.

4. The system of claim 2:
wherein, using a defined recipe, the dispensing circuitry further determines a respective volume of each of a plurality of liquids to dispense into the container; and
wherein the total of the respective determined volumes of each of the plurality of liquids provides the determined fill volume.

5. The system of claim 4 wherein the fill volume circuitry accounts for a volume loss in the container when determining the fill volume, the volume loss attributable, at least in part, to a volume occupied by one or more objects in the container.

6. The system of claim 1:
wherein the container comprises a closed bottom hollow vessel in the form of an inverted conical frustum having a smaller diameter closed end and a larger diameter open end;
wherein the fill volume circuitry determines the fill volume to achieve a desired ratio of a detected diameter of a liquid level within the container to an end diameter of the larger diameter open end of the container.

7. The system of claim 1, further comprising a container detection circuitry to autonomously detect the container;
wherein the fill volume circuitry autonomously determines the fill volume of the container upon autonomous detection of the container by the container detection circuitry.

8. The system of claim 1 wherein the data acquisition system comprises a stereoscopic data acquisition system that includes a plurality of image acquisition devices arranged to provide a stereoscopic image of the container.

9. The system of claim 1 wherein the data acquisition system comprises a structured light data acquisition system that includes a structured light illuminator communicably coupled to at least one image acquisition device.

10. The system of claim 9 wherein the structured light illuminator generates an output in a visible electromagnetic spectrum of 390 nanometers (nm) to 700 nm and the at least one image acquisition device includes an image acquisition device sensitive to the visible electromagnetic spectrum.

11. The system of claim 9 wherein the structured light illuminator generates an output in the infrared light electromagnetic spectrum above 700 nm and the at least one image acquisition device includes an infrared image acquisition device.

12. An automated dispensing method, comprising:
generating a three-dimensional model of a container using a data acquisition system;
determining, by dimensioning circuitry, at least one physical dimension of the container using the generated three-dimensional model;
determining, by available internal volume circuitry, an available internal volume of the container using the at least one determined physical dimension of the container;
determining, by fill volume circuitry, a fill volume to provide a defined fill level within the container based on the available internal volume of the container; and
dispensing, by dispensing circuitry, the fill volume of at least one material into the container.

13. The method of claim 12 wherein dispensing the fill volume of at least one material into the container, further comprises:
causing, by the dispensing circuitry, a communicably coupled liquid dispensing system to dispense the fill volume of at least one liquid into the container.

14. The method of claim 13, further comprising:
determining, by the available internal volume circuitry, an available internal volume that accounts for a volume loss in the container attributable, at least in part, to one or more objects present in the container.

15. The method of claim 14, further comprising:
determining, by the dispensing circuitry, a respective volume of each of a plurality of liquids to dispense to the container, wherein the total of the respective determined volumes of each of the plurality of liquids provides the determined fill volume.

16. The method of claim 14 wherein determining an available internal volume that accounts for a volume loss in the container attributable, at least in part, to one or more objects deposited in the container comprises:
determining, by the available internal volume circuitry, an available internal volume that accounts for a volume loss in the container attributable, at least in part, to one or more ice cubes present in the container.

17. The method of claim 12, further comprising:
autonomously detecting the container by container detection circuitry; and
autonomously determining, by the fill volume circuitry, the fill volume of the container responsive to the autonomous detection of the container by the container detection circuitry.

18. The method of claim 12 wherein generating a three-dimensional model of a container further comprises:
generating a three-dimensional model of a container using a stereoscopic data acquisition system that includes a plurality of image acquisition devices arranged to provide a stereoscopic image of the container.

19. The method of claim 12 wherein generating a three-dimensional model of a container further comprises:
generating a three-dimensional model of a container using a structured light data acquisition system that includes a structured light illuminator communicably coupled to at least one image acquisition device.

20. The method of claim 19 wherein generating a three-dimensional model of a container using a structured light data acquisition system further comprises:
generating a three-dimensional model of a container using a structured light data acquisition system that includes a structured light illuminator that generates an output in a visible electromagnetic spectrum of 390 nanometers (nm) to 700 nm; and
acquiring an image of the illuminated container using at least one image acquisition device sensitive to the visible electromagnetic spectrum.

21. The method of claim 19 wherein generating a three-dimensional model of a container using a structured light data acquisition system further comprises:
generating a three-dimensional model of a container using a structured light data acquisition system that includes a structured light illuminator that generates an output in an infrared electromagnetic spectrum above 700 nm; and
acquiring an image of the illuminated container using at least one image acquisition device sensitive to the infrared electromagnetic spectrum.

22. A non-transitory machine-readable storage medium containing instructions that, when executed, cause controller circuitry to:
cause a data acquisition system to generate a three-dimensional model of a container;
cause dimensioning circuitry to determine a at least one internal physical dimension of the container based, at least in part, on the three-dimensional model of the container;
cause available internal volume circuitry to determine an available internal volume of the container using the at least one internal physical dimension of the container;
cause fill volume circuitry to determine a fill volume to provide a defined fill level within the container based on the available internal volume in the container; and
cause dispensing circuitry to dispense the fill volume of at least one material into the container.

23. The non-transitory machine-readable storage medium of claim 22 wherein the instructions that cause the dispensing circuitry to dispense the fill volume of at least one material into the container, further cause the dispensing circuitry to:
cause a communicably coupled liquid dispensing system to dispense the fill volume of at least one liquid into the container.

24. The non-transitory machine-readable storage medium of claim 23 wherein the machine-readable instructions further cause the available internal volume circuitry to:
determine an available internal volume that accounts for a volume loss in the container attributable, at least in part, to a presence of one or more objects disposed in the container.

25. The non-transitory machine-readable storage medium of claim 24 wherein the machine-readable instructions further cause the dispensing circuitry to:
determine, using the dispensing circuitry, a respective volume of each of a plurality of liquids to dispense to the container, wherein the total of the respective determined volumes of each of the plurality of liquids provides the determined fill volume.
